(19) United States
(12) Patent Application Publication
(10) Pub. No.: US 2025/0342988 A1
(43) Pub. Date: Nov. 6, 2025

(54) LASER CLEANING AND ACTIVATION OF CU WIRES PRIOR TO PEEK INSULATION COATING

(71) Applicant: Schaeffler Technologies AG & Co. KG, Herzogenaurach (DE)

(72) Inventors: Mitchell Valaitis, Eastlake, OH (US); Murat Bakan, Canton, OH (US)

(21) Appl. No.: 18/654,848

(22) Filed: May 3, 2024

(51) Int. Cl. H01B 13/14; B05C 5/02; B05C 9/10; B05D 3/06; B05D 7/20

(52) U.S. Cl. CPC H01B 13/145; B05C 5/0241; B05C 9/10; B05D 3/06; B05D 7/20; H01B 13/148; B05D 2202/45; B05D 2256/00; B05D 2518/00

(57) ABSTRACT

A coating system may include a feed mechanism including one or more rollers configured to provide a supply of a wire conductor through a working zone with a feed rate, an extruder to coat the wire conductor with a coating as the wire conductor is fed through the working zone, and a laser processing sub-system in the working zone prior to the extruder. The laser processing sub-system may include one or more laser sources to illuminate a surface of the wire conductor with two or more laser beams as the wire conductor is fed through the working zone, where laser processing parameters associated with the laser processing sub-system are selected to activate the surface of the wire conductor for adhesion of the coating. The laser processing parameters may include intensities of the two or more laser beams, spectra of the two or more laser beams, and/or the feed rate.

### TECHNICAL FIELD

The present disclosure relates generally to processes for coating wires and, more particularly, to laser processing of wires prior to application of a coating for improved performance.

### BACKGROUND

Next generation electric vehicle (EV) motors utilize large amounts of flat magnet wires that operate at high voltages (≥800 V). Thermoset enamel coatings have been the historical solution for electrically insulating magnet wires, but are not appropriate for next generation motors since enamel coatings are relatively brittle, prone to cracking, and are difficult to achieve coating film builds greater than 100 μm. This results in most enamel coated magnet wires failing in motors that have nominal operating voltages greater than 600-700 V. By comparison, PEEK (polyether ether ketone) insulated magnet wires have average coating film build thicknesses ranging from 150 μm-200 μm and can be much greater if desired. This greater film build thickness results in PEEK insulated magnet wires being able to operate in motors with much higher nominal operating voltages, in some cases well above 1,000 V.

The drawback of PEEK magnet wire insulation is that the coating adhesion strength of PEEK to the wire conductor (e.g., copper (Cu), or the like) tends to be much lower than that of enamel. One reason for relatively low adhesion strength of PEEK coatings relates to the adhesion mechanism. In particular, enamel coatings may chemically bond to the wire conductor, while PEEK coatings typically only physically adheres to the surface of the wire conductor.

One approach to improving the adhesion of PEEK coatings is to develop new grades of PEEK thermoplastic that incorporate functionalized PEEK polymer chains and are compounded with additives such as talc in order to promote stronger physical bonds between PEEK and the wire connector (e.g., Cu). Another approach to improving the adhesion of PEEK coatings is to pre-clean the wire conductors prior to adhesion using techniques such as steam cleaning or plasma activation. Another approach to improving the adhesion of PEEK coatings is to apply a bond coat such as polyester or Polyamide-imide (PAI) to the wire conductor prior to application of the PEEK coating. However, the current techniques are too slow, add undesirable material to the wires, and/or are relatively expensive. There is therefore a need to develop systems and methods to cure the above deficiencies.

### SUMMARY

In embodiments, the techniques described herein relate to a coating system including a feed mechanism including one or more rollers configured to provide a supply of a wire conductor through a working zone with a feed rate; an extruder to coat the wire conductor with a coating as the wire conductor is fed through the working zone; and a laser processing sub-system in the working zone prior to the extruder, where the laser processing sub-system includes one or more laser sources configured to illuminate a surface of the wire conductor with two or more laser beams as the wire conductor is fed through the working zone, where one or more laser processing parameters associated with the laser processing sub-system are selected to activate the surface of the wire conductor for adhesion of the coating, where the one or more laser processing parameters include at least one of intensities of the two or more laser beams, spectra of the two or more laser beams, or the feed rate.

In embodiments, the techniques described herein relate to a coating system, where the one or more laser processing parameters are selected to activate the surface of the wire conductor for adhesion of the coating by increasing a surface energy of the surface of the wire conductor.

In embodiments, the techniques described herein relate to a coating system, where the one or more laser processing parameters are selected to activate the surface of the wire conductor for adhesion of the coating by removing contaminants from the surface of the wire conductor.

In embodiments, the techniques described herein relate to a coating system, where the one or more laser processing parameters are selected to activate the surface of the wire conductor for adhesion of the coating by increasing a surface roughness of the surface of the wire conductor.

In embodiments, the techniques described herein relate to a coating system, where the two or more laser beams are arranged to illuminate an entire surface of the wire conductor with the two or more laser beams as the wire conductor is fed through the working zone.

In embodiments, the techniques described herein relate to a coating system, where the two or more laser beams are arranged in a non-overlapping configuration.

In embodiments, the techniques described herein relate to a coating system, where the two or more laser beams include two or more pulsed laser beams, where the one or more laser processing parameters further include at least one of a temporal pattern or a spatial pattern of pulses in the two or more pulsed laser beams.

In embodiments, the techniques described herein relate to a coating system, where the coating includes polyether ether ketone (PEEK), where the wire conductor includes copper.

In embodiments, the techniques described herein relate to a coating system, where the one or more laser processing parameters are selected to activate the surface of the wire conductor for adhesion of the coating by increasing a surface energy of the surface of the wire conductor above 50 mN/m.

In embodiments, the techniques described herein relate to a system for laser processing including one or more laser sources configured to illuminate a surface of a wire conductor with one or more laser beams as the wire conductor is translated along a length of the wire conductor at a feed rate, where one or more laser processing parameters associated are selected to activate the surface of the wire conductor for adhesion of a coating, where the one or more laser processing parameters include at least one of intensities of the one or more laser beams or the feed rate.

In embodiments, the techniques described herein relate to a system, where the one or more laser processing parameters are selected to activate the surface of the wire conductor for adhesion of the coating by increasing a surface energy of the surface of the wire conductor.

In embodiments, the techniques described herein relate to a system, where the one or more laser processing parameters are selected to activate the surface of the wire conductor for adhesion of the coating by removing contaminants from the surface of the wire conductor.

In embodiments, the techniques described herein relate to a system, where the one or more laser processing parameters are selected to activate the surface of the wire conductor for adhesion of the coating by increasing a surface roughness of the surface of the wire conductor.

In embodiments, the techniques described herein relate to a system, where the coating includes PEEK, where the wire conductor includes copper.

In embodiments, the techniques described herein relate to a system, where the one or more laser processing parameters are selected to activate the surface of the wire conductor for adhesion of the coating by increasing a surface energy of the surface of the wire conductor above 50 mN/m.

In embodiments, the techniques described herein relate to a laser surface activation method including determining one or more laser processing parameters associated with a laser processing sub-system to activate the surface of a wire conductor for adhesion of a coating, where the laser processing sub-system includes one or more laser sources configured to illuminate a surface of the wire conductor with two or more laser beams as the wire conductor is translated along a length of the wire conductor at a feed rate, where the one or more laser processing parameters include at least one of intensities of the two or more laser beams, spectra of the two or more laser beams, or the feed rate; translating the wire conductor along the length of the wire conductor at the feed rate; activating the surface of the wire conductor with the laser processing sub-system using the one or more laser processing parameters; and applying the coating to the wire conductor.

In embodiments, the techniques described herein relate to a method, where the one or more laser processing parameters are selected to activate the surface of the wire conductor for adhesion of the coating by increasing a surface energy of the surface of the wire conductor.

In embodiments, the techniques described herein relate to a method, where the one or more laser processing parameters are selected to activate the surface of the wire conductor for adhesion of the coating by removing contaminants from the surface of the wire conductor.

In embodiments, the techniques described herein relate to a method, where the one or more laser processing parameters are selected to activate the surface of the wire conductor for adhesion of the coating by increasing a surface roughness of the surface of the wire conductor.

In embodiments, the techniques described herein relate to a method, where the coating includes PEEK, where the wire conductor includes copper, where the one or more laser processing parameters are selected to activate the surface of the wire conductor for adhesion of the coating by increasing a surface energy of the surface of the wire conductor above 50 mN/m.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 illustrates a block diagram of a wire coating system, in accordance with one or more embodiments of the present disclosure.

FIG. 2 illustrates a simplified schematic of an extruder, in accordance with one or more embodiments of the present disclosure.

FIG. 3A illustrates a cross-sectional view of a round coated wire conductor, in accordance with one or more embodiments of the present disclosure.

FIG. 3B illustrates a cross-sectional view of a rectangular coated wire conductor, in accordance with one or more embodiments of the present disclosure.

FIG. 4A illustrates a simplified cross-sectional view of a wire conductor in a first non-limiting configuration of a laser processing sub-system, in accordance with one or more embodiments of the present disclosure.

FIG. 4B is a simplified perspective view of the wire conductor in the laser processing sub-system of FIG. 4A, in accordance with one or more embodiments of the present disclosure.

FIG. 4C illustrates a simplified cross-sectional view of a wire conductor in a second non-limiting configuration of the laser processing sub-system, in accordance with one or more embodiments of the present disclosure.

FIG. 5A is a pareto chart depicting an impact of laser processing parameters on Rₐ surface roughness of a wire conductor, in accordance with one or more embodiments of the present disclosure.

FIG. 5B is a pareto chart depicting an impact of laser processing parameters on R_{z} surface roughness of a wire conductor, in accordance with one or more embodiments of the present disclosure.

FIG. 5C is a pareto chart depicting an impact of laser processing parameters on water receding contact angle of a wire conductor, in accordance with one or more embodiments of the present disclosure.

FIG. 5D is a pareto chart depicting an impact of laser processing parameters on water advancing angle of a wire conductor, in accordance with one or more embodiments of the present disclosure.

FIG. 5E is a pareto chart depicting an impact of laser processing parameters on surface energy of a wire conductor, in accordance with one or more embodiments of the present disclosure.

FIG. 6 is a flow diagram illustrating steps performed in a method for laser surface activation of a wire conductor, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing laser surface activation of a wire conductor to enhance an adhesion strength of a coating on the wire conductor.

The systems and methods disclosed herein may be applied to any conductor and/or coating composition. In some embodiments, the wire conductor is a copper and the coating is a polymer coating such as, but not limited to, a polyaryletherketone (PAEK) coating. For example, the coating may be a polyether ether keytone (PEEK) coating. Such a combination may be utilized for, but is not limited to, magnet wires for next-generation electric vehicle (EV) motors. In particular, PEEK and other coatings may provide increased coating thickness, tighter wire bend radii due to greater coating elongation, and may provide for higher nominal operating voltages than enamel coatings, but may suffer from relatively lower adhesion strength than enamel coatings when applied using existing techniques. Whereas enamel coatings may adhere to a wire conductor through chemical bonds, coatings such as PEEK may adhere through physical bonds. Further, although new grades of PEEK under development may include functionalized PEEK polymer chains and may be compounded with additives such as talk in order to promote physical bonds with the wire conductor, adhesion strength remains an unsolved challenge.

Embodiments of the present disclosure are directed to enhancing the adhesion strength of a coating on a wire conductor (e.g., PEEK on a copper wire conductor, or any other suitable combination) through laser surface activation of a surface of the wire conductor prior to application of the coating. As an illustration, the adhesion strength of PEEK on a copper wire conductor may improve with increasing surface energy and may achieve desired performance characteristics when the surface energy is at or above a target value of 50 nM/m. It is to be understood, however, that such a target value is merely exemplary and should not be interpreted as limiting the scope of the present disclosure. Rather, laser surface activation as disclosed herein may be used to achieve any target value of surface energy for any application.

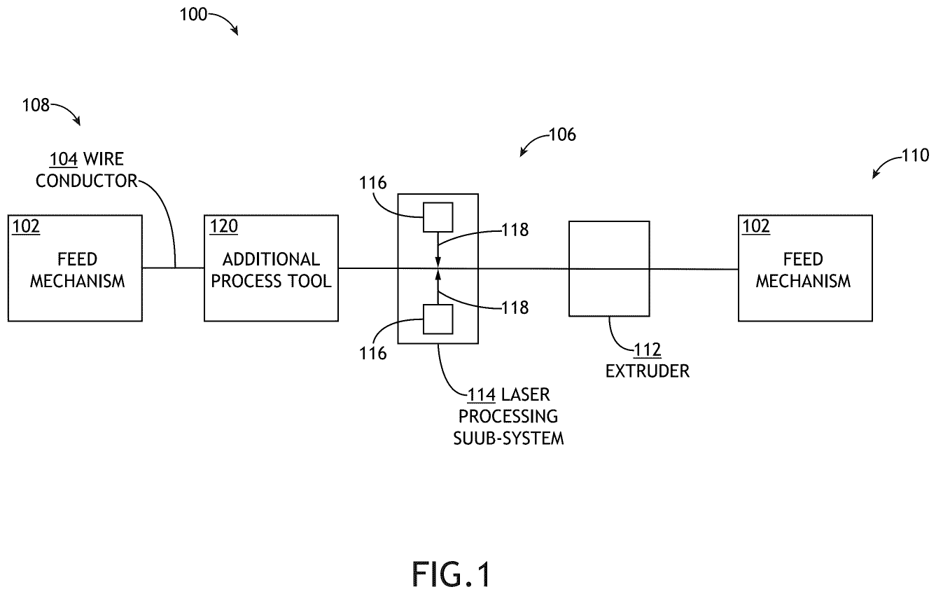

Referring now to FIGS. 1-6, systems and methods providing laser surface activation of a wire conductor to enhance an adhesion strength of a coating on the wire conductor are described in greater detail, in accordance with one or more embodiments of the present disclosure.

FIG. 1 illustrates a block diagram of a wire coating system 100, in accordance with one or more embodiments of the present disclosure.

In embodiments, the wire coating system 100 includes a feed mechanism 102 to provide a supply of a wire conductor 104 through a working zone 106 with a selected feed rate. The feed mechanism 102 may include any combination of components suitable for providing a supply of wire conductor 104 through a working zone 106 including various equipment to manipulate the wire conductor 104. For example, the feed mechanism 102 may include one or more rollers on a payoff side 108 to feed wire conductor 104 from a payoff spool to various equipment within the working zone 106 and may further include one or more rollers on a wind-up side 110 to receive the wire conductor 104 from the working zone 106 and wind the processed wire conductor 104 on a wind-up spool. As another example, the feed mechanism 102 may include a wire drawdown tower to provide the supply of wire conductor 104 to the working zone 106 and one or more rollers on a wind-up side to receive the wire conductor 104 from the working zone 106.

The wire coating system 100 may include any number of processing tools to perform various processing steps on the wire conductor 104 as it is fed through the working zone 106.

In embodiments, the wire coating system 100 includes an extruder 112 to apply a polymer coating to the wire conductor 104. The extruder 112 may apply any composition of coating such as, but not limited to, a PEEK coating or any PAEK type polymer coating.

The extruder 112 may include any component or combination of components suitable for applying a selected coating to the wire conductor 104. It is contemplated herein that numerous designs of the extruder 112 are possible within the spirit and scope of the present disclosure, where different designs may provide different tradeoffs with respect to various aspects of the applied coating such as, but not limited to, uniformity or thickness.

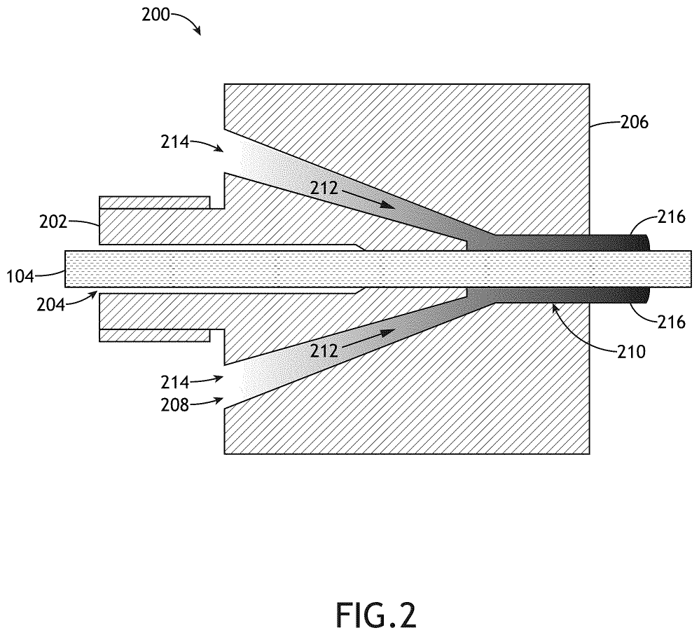

FIG. 2 illustrates a simplified schematic of an extruder 112, in accordance with one or more embodiments of the present disclosure. In FIG. 2, a mandril 202 with a feed-through opening 204 sized to receive the wire conductor 104 and a die 206 with a tapered opening 208 sized to receive the mandril 202. The die 206 may further include an additional feed-through opening 210 to receive the wire conductor 104 and optionally a portion of the mandril 202. In this configuration, the wire conductor 104 may be fed through the feed-through opening 204 of the mandril 202 and then through the feed-through opening 210 of the die 206. Further, coating material 212 may flow through a channel 214 formed between the tapered opening 208 and an outer surface of the mandril 202 to contact and coat the wire conductor 104.

In the particular configuration depicted in FIG. 2, the coating material 212 and the wire conductor 104 flow through a portion of the feed-through opening 210 of the die 206 before exiting the die 206 to provide a coated wire conductor 104 (e.g., a wire conductor 104 with a coating 216 formed from the coating material 212), which may be characterized as a pressure/compression extrusion configuration. In this configuration, the thickness of the coating 216 may be determined by a size of a gap between the wire conductor 104 and the feed-through opening 210 of the die 206. For example, the thickness of the coating 216 may be expressed as (d_{die}-d_{wireConductor})/2, where d_{die} is a diameter of the feed-through opening 210 of the die 206 in a particular dimension and die_{wireConductor} is a diameter of the wire conductor 104 in the particular dimension.

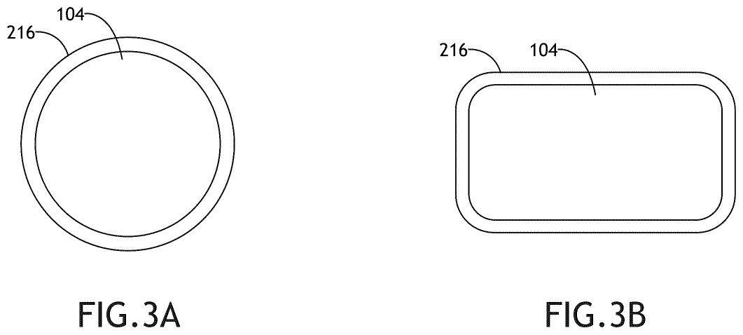

The extruder 112 may be configured to apply the coating 216 to a wire conductor 104 having any cross-sectional shape such as, but not limited to, circular, square, or rectangular. Further, any non-circular cross-sectional shape may have sharp or rounded corners. FIG. 3A illustrates a cross-sectional view of a round coated wire conductor 104, in accordance with one or more embodiments of the present disclosure. FIG. 3B illustrates a cross-sectional view of a rectangular coated wire conductor 104, in accordance with one or more embodiments of the present disclosure. In embodiments, cross-sectional shapes of the feed-through opening 204 of the mandril 202 as well as the feed-through opening 210 of the die 206 are designed based on the cross-sectional shape of the wire conductor 104 to provide a uniform coating 216.

It is to be understood that FIG. 2 and the associated description are provided solely for illustrative purposes and should not be interpreted as limiting the scope of the present disclosure. The design of the extruder 112 in FIG. 2 may be varied in numerous ways within the spirit and scope of the present disclosure. For example, the outer portion of the mandril 202 and the shape of the tapered opening 208 of the die 206 may be designed to control various properties of the channel 214 through which the coating material 212 flows such as, but not limited to, the width of the channel 214 at any point which may or may not decrease along the length of the channel 214 to provide tapering as depicted in FIG. 2, an angle between the channel 214 and the wire conductor 104, or a length of the channel 214. Further, as described previously herein, the extruder 112 is not limited to the design depicted in FIG. 2. As an illustration, the mandril 202 and/or the die 206 may be designed such that the coating material 212 contacts the wire conductor 104 after the die, where a vacuum is pulled in a space between the coating material 212 and the wire conductor 104 after the die 206. Such a configuration may be characterized as a tubing/sleeve configuration, which may potentially provide higher feed rates, but may result in reduced adhesion strength and/or thinner coatings. In any case, any design of an extruder 112 suitable for applying a coating 216 with desired characteristics is within the spirit and scope of the present disclosure.

In embodiments, the wire coating system 100 includes a laser processing sub-system 114 to pre-treat (e.g., activate) the wire conductor 104 prior to entering the extruder 112 for application of the coating 216.

The laser processing sub-system 114 may include one or more laser sources 116 arranged to illuminate a surface of the wire conductor 104 with two or more beams 118 of laser light (e.g., laser beams) as the wire conductor 104 is fed through the working zone 106 by the feed mechanism 102.

The beams 118 of laser light may have any selected temporal or spectral characteristics. For example, the beams 118 of laser light may include one or more wavelengths in any spectral band, or combination of spectral bands including, but not limited to, ultraviolet light, visible light, or infrared light. As another example, the beams 118 of laser light may be formed as continuous-wave (CW) light or pulsed laser light. In the case of pulsed laser light, the beams 118 may include pulses with any pulse duration. For instance, the beams 118 of laser light may include pulses with pulse durations on the order of microseconds, nanoseconds, picoseconds, femtoseconds, or attoseconds. As an illustration, the pulse duration may be in a range from 100 microsecond to 1 femtosecond or lower. Additionally, the beams 118 of laser light may include pulses with any temporal pattern or spacing. As an illustration, the beams 118 of laser light may include pulses with a constant repetition rate of any value such as, but not limited to, on an order of Hz, kHz, or MHz. As another illustration, the beams 118 of laser light may include pulses with patterned temporal sequence.

The one or more laser sources 116 may include any type of source known in the art that generates beams 118 of laser light suitable for activating a surface of a wire conductor 104 of a selected composition. For example, the one or more laser sources 116 may include, but are not limited to, one or more diode lasers, one or more fiber lasers, one or more solid-state lasers, one or more gas lasers, or one or more quantum cascade lasers.

The one or more laser sources 116 may be arranged in any configuration to illuminate a surface of the wire conductor 104 with any number of beams of laser light to provide a desired activation of the surface. Further, the beams 118 of laser light may have any spot size or shape when incident on the wire conductor 104. For example, any of the beams may have a circular beam shape, an elliptical beam shape, or a flat-top beam shape. Additionally, any of the beams may be diverging, converging, or at a focal point when incident on the wire conductor 104.

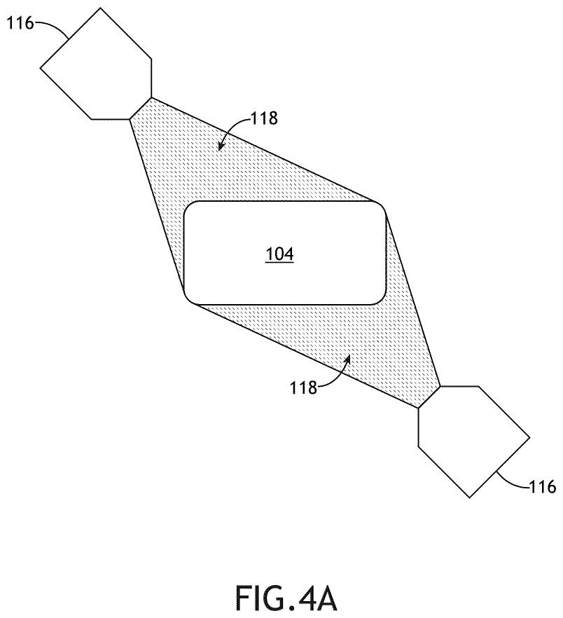

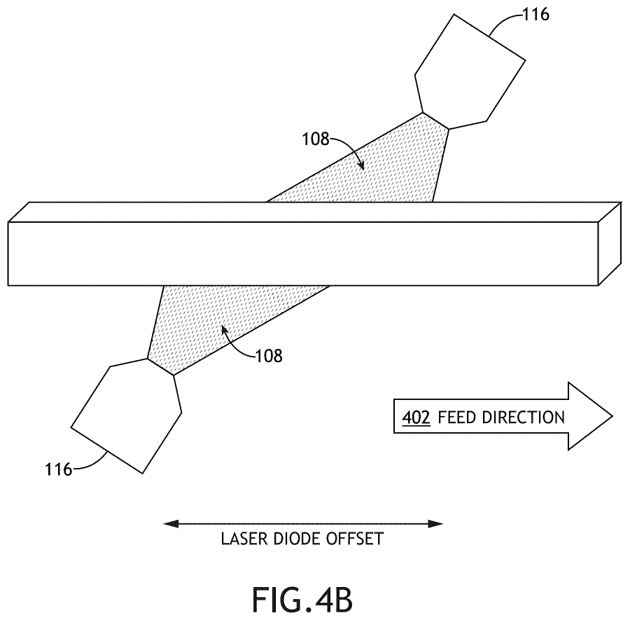

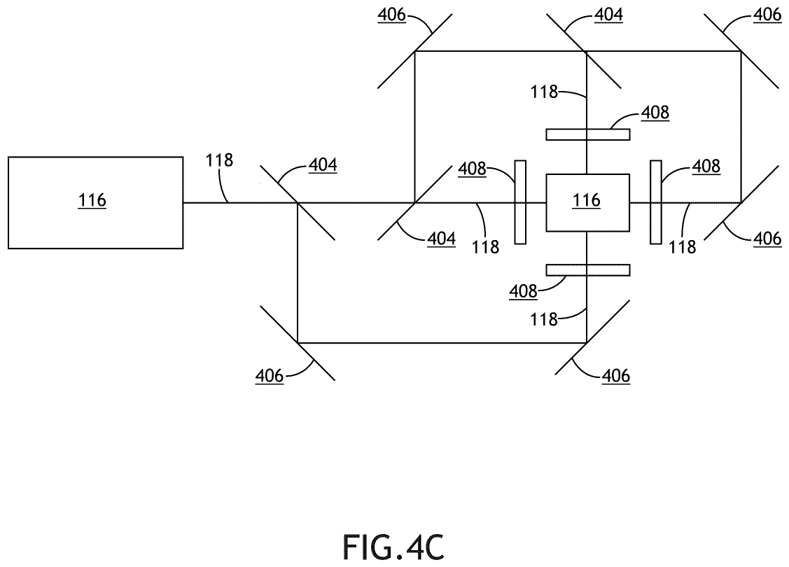

FIGS. 4A-4C depict various non-limiting configurations of the laser processing sub-system 114, in accordance with one or more embodiments of the present disclosure.

FIG. 4A illustrates a simplified cross-sectional view of a wire conductor 104 in a first non-limiting configuration of a laser processing sub-system 114, in accordance with one or more embodiments of the present disclosure. FIG. 4B is a simplified perspective view of the wire conductor 104 in the laser processing sub-system 114 of FIG. 4A, in accordance with one or more embodiments of the present disclosure. In the configuration of FIG. 4A-4B, two laser sources 116 are positioned to illuminate the wire conductor 104 with beams 118 of laser light from different directions. For example, the two laser sources 116 in FIGS. 4A-4B are positioned on opposing corners of a rectangular wire conductor 104, where the beams 118 fully illuminate the surface of the wire conductor 104 as it is fed along the feed direction 402 (e.g., by the feed mechanism 102). The various laser processing sub-system 114 may be distributed in any configuration along the feed direction 402 (e.g., orthogonal to a cross-section of the wire conductor 104). FIG. 4B illustrates a configuration in which the two laser processing sub-system 114 are offset along the feed direction 402, which may prevent any overlap of the beams 118 on the wire conductor 104 and associated cumulative or interference effects.

FIG. 4C illustrates a simplified cross-sectional view of a wire conductor 104 in a second non-limiting configuration of the laser processing sub-system 114, in accordance with one or more embodiments of the present disclosure. In FIG. 4C, the laser processing sub-system 114 includes a single laser source 116 along with a series of beamsplitters 404 and mirrors 406 arranged to split light from the single laser source 116 into four beams 118 and direct these four beams 118 to different sides of a rectangular wire conductor 104. In this configuration, splitting ratios of the various beamsplitters 404 may be adjusted to provide that the four beams 118 have equal power (or intensity) such that the illumination conditions on the different sides of the wire conductor 104 may be equivalent. Although not explicitly shown in the cross-sectional view of FIG. 4C, the beams 118 may be directed to the wire conductor 104 at different offset positions along the feed direction 402 (here, orthogonal to the plane of the figure) in a manner similar to that shown in FIG. 4B to prevent overlap and associated effects.

As further depicted in FIG. 4C, the laser processing sub-system 114 may include beamshaping optical elements 408 at any location to control the physical distributions of the beams 118 on the surface of the wire conductor 104. The beamshaping optical elements 408 may include any optical element or combination of optical elements suitable for controlling the physical distributions of the beams 118 on the surface of the wire conductor 104.

For example, the beamshaping optical elements 408 may include one or more lenses to focus the beams 118 to selected spot size and shape. As an illustration, a rotationally-symmetric lens may provide a circular beam shape. As another illustration, a cylindrical lens may provide an elliptical beam shape.

As another example, the beamshaping optical elements 408 may include one or more optical elements configured to provide a uniform beam intensity profile for any of the beams 118 (e.g., a flat-top beam profile) such as, but not limited to, diffractive optical elements or axicons.

It is contemplated that the laser processing sub-system 114 may utilize any suitable technique to illuminate the surface of the wire conductor 104 with various beams 118 of laser light. For example, profiles of the beams 118 may be adjusted to fully cover an entire surface of the wire conductor 104 as it is fed through the working zone 106 without requiring movement of the beams 118. As another example, the laser processing sub-system 114 may include beam-scanning optics (e.g., actuatable mirrors with adjustable tip and/or tilt) to scan one or more of the beams 118 in a direction orthogonal to the feed direction 402 as the wire conductor 104 is fed through the working zone 106 along the feed direction 402. In this configuration, the profiles of any scanned beams 118 may be smaller than the wire conductor 104 (e.g., to provide increased intensity required for a desired effect).

Referring generally to FIGS. 4A-4C, it is to be understood that FIGS. 4A-4C are provided solely for illustrative purposes and should not be interpreted as limiting the scope of the present disclosure. For example, the laser processing sub-system 114 may include any combination of components to illuminate the wire conductor 104 with any number of beams 118 in any configuration. As another example, the laser processing sub-system 114 may provide multiple sets of beams 118 along the feed direction 402 in overlapping or non-overlapping configurations to achieve any desired effect on the wire conductor 104. As an illustration, the laser processing sub-system 114 may provide a first set of beams 118 with a first set of illumination parameters (e.g., temporal, spectral, and/or spatial characteristics) and a second set of beams 118 with a second set of illumination parameters, where both the first set of beams 118 and the second set of beams 118 fully illuminate the surface of the wire conductor 104. In this configuration, the first set of beams 118 and the second set of beams 118 may be tailored to provide different pre-treatment effects.

Laser surface activation for increased adhesion of a coating 216 is described in greater detail, in accordance with one or more embodiments of the present disclosure.

The laser processing sub-system 114 may activate the surface of the wire conductor 104 using any technique. For example, the laser processing sub-system 114 may activate the surface of the wire conductor 104 by increasing a surface energy of a surface of the wire conductor 104 (e.g., to a value at or above a selected threshold). As an illustration, the adhesion strength of a PEEK coating to a copper wire conductor 104 may generally increase as the surface energy increases. Further, providing a surface energy of a copper wire conductor 104 at or above a selected threshold of 50 mN/m may result in the adhesion of a PEEK coating that meets or exceeds application tolerances for use as a magnetic wire in EV motor applications. However, it is to be understood that this is merely an illustration. In embodiments, the laser processing sub-system 114 may increase a surface energy of a wire conductor 104 of any selected composition to meet or exceed any selected threshold value, where this selected threshold value may be determined based on any application requirements.

It is contemplated herein that the surface energy of a wire conductor 104 may be impacted by a wide range of factors including, but not limited to, the presence of contaminants, a surface roughness, or surface profile more generally. In embodiments, various laser processing parameters may be selected to control a surface energy of the wire conductor 104 by addressing any of these factors. For example, the laser processing parameters may include various properties of any of the beams 118 such as, but not limited to, spectral properties (e.g., a center wavelength, a bandwidth, a spectrum, or the like), temporal properties (e.g., pulse durations, a repetition rate of pulses, a temporal pattern of pulses, or the like), or spatial properties (e.g., a beam profile on the wire conductor 104). As another example, the laser processing parameters may include properties associated with the wire conductor 104 such as, but not limited to, a feed rate of the wire conductor 104 through the laser processing sub-system 114, which may impact the spatial separation between pulses of a fixed repetition rate along the feed direction 402 and thus the energy density (e.g. fluence) directed to the wire conductor 104.

In some embodiments, laser processing parameters provided by the laser processing sub-system 114 are selected to remove surface contaminants without substantially impacting the surface profile and/or surface roughness of the wire conductor 104. For example, the laser processing parameters provided by the laser processing sub-system 114 are selected to remove surface contaminants and maintain a surface roughness of the wire conductor 104 within a selected tolerance (e.g., less than a 1% change, less than a 5% change, less than a 10% change, or the like). Further, the surface contaminants may be removed by any mechanism including, but not limited to, evaporation, sublimation, or ablation (e.g., explosive material removal).

In some embodiments, laser processing parameters provided by the laser processing sub-system 114 are selected to manipulate the surface profile and/or the surface roughness of the wire conductor 104. In many cases, such conditions may remove surface contaminants as well, but this is not a requirement. For example, the laser processing parameters provided by the laser processing sub-system 114 are selected to remove surface contaminants and increase a surface roughness of the wire conductor 104 by at least a selected threshold (e.g., greater than a 1% change, greater than a 5% change, greater than a 10% change, or the like).

It is contemplated herein that the mechanisms governing light-matter interaction with any surface contaminants and/or the material of the wire conductor 104 itself may critically depend on the precise laser processing parameters as well as the compositions of the surface contaminants and/or the material of the wire conductor 104.

For example, absorption of laser light may depend critically on the absorption spectrum of a material (e.g., surface contaminants and/or the material of the wire conductor 104 itself) for relatively low to moderate laser intensities. However, when the laser intensity becomes sufficiently high (e.g., when using pulsed beams 118 with pulse durations on the order of picoseconds, femtosecond, or lower), non-linear absorption mechanisms may dominate even for wavelengths outside of an absorption line. Further, precise values of laser processing parameters such as, but not limited to, the laser intensity and the pulse overlap (e.g., spatial and/or temporal overlap of pulses) may critically impact the response of the material to absorbed laser energy and thus the resulting surface profile. As an illustration, some combinations of laser processing parameters may result in localized heating of the material and the formation of various surface structures (e.g., a modification of surface roughness) without material removal, whereas other combinations of laser processing parameters may physically remove portions of the wire conductor 104 (and possibly the surface contaminants) through processes such as, but not limited to, ablation.

It is thus contemplated herein that the laser processing sub-system 114 may utilize any combination of laser processing parameters suitable for increasing a surface energy of the wire conductor 104 in a manner that increases the adhesion strength of a selected coating relative to an unprocessed state.

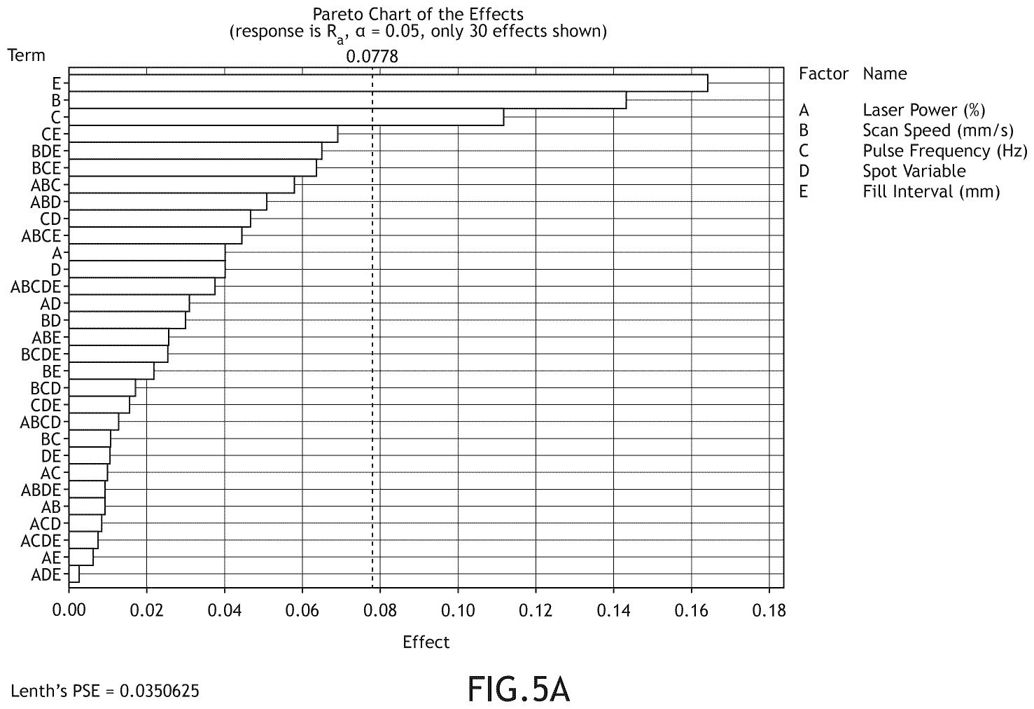

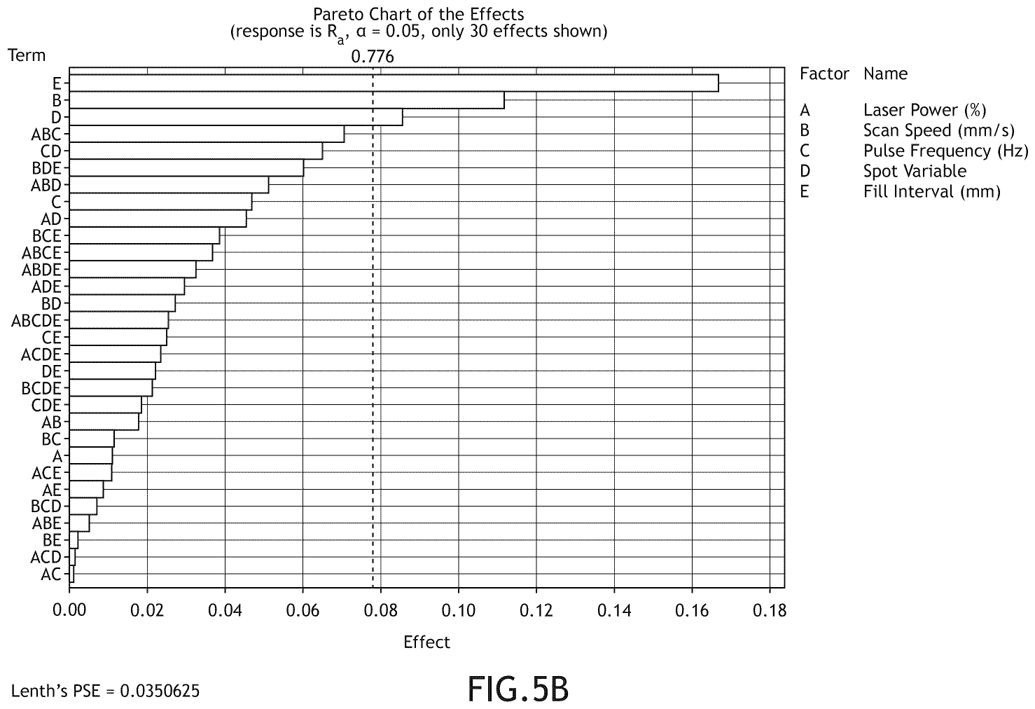

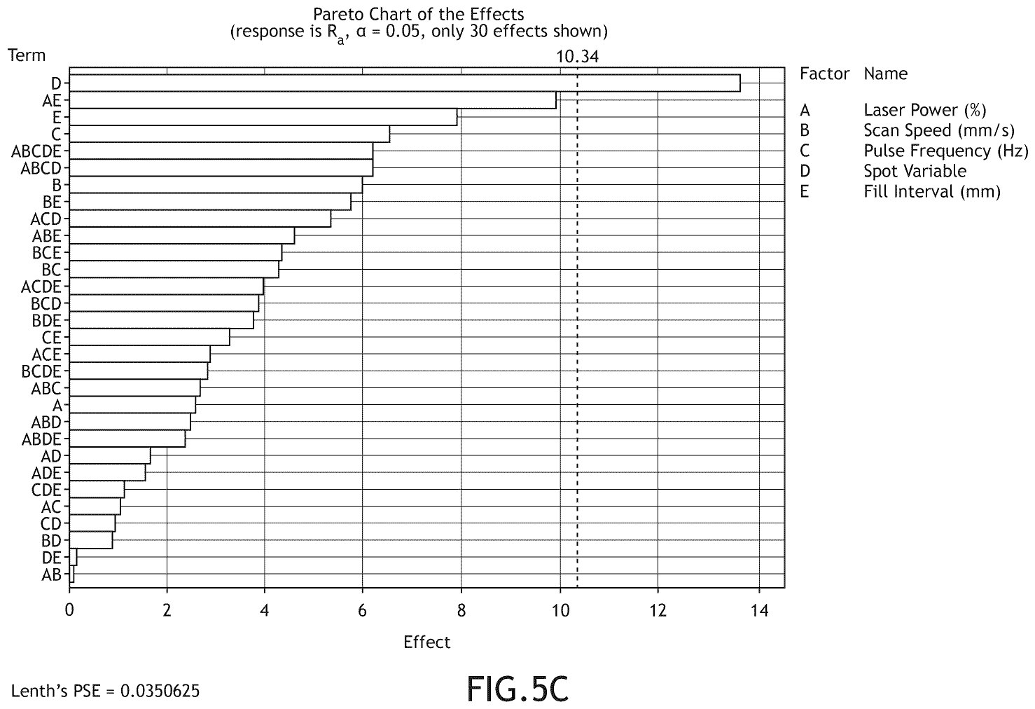

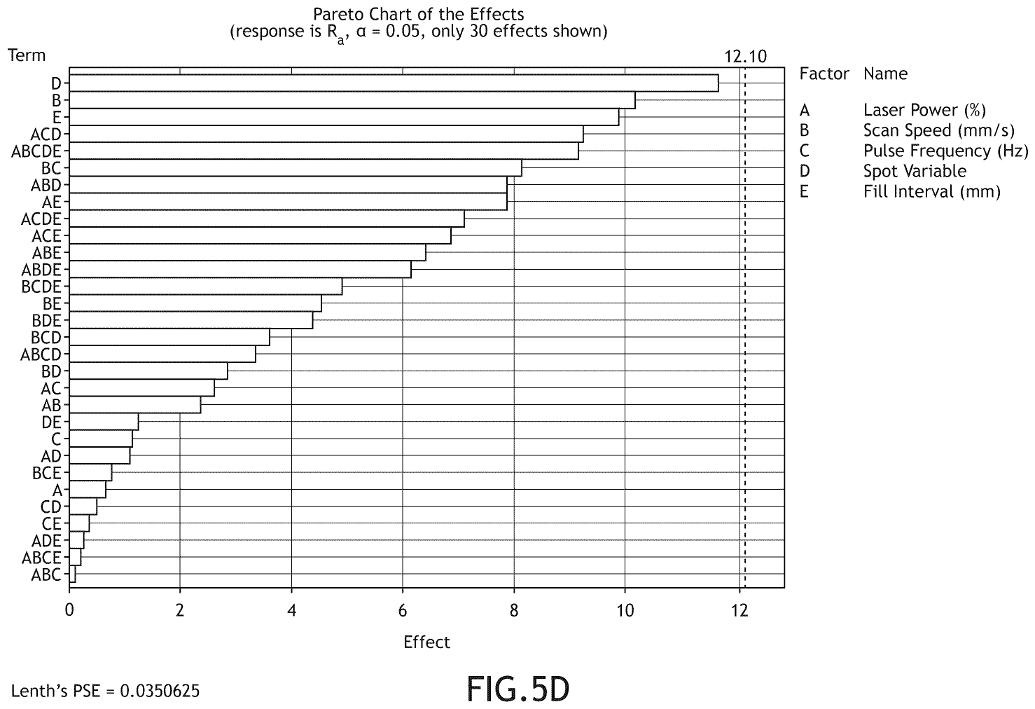

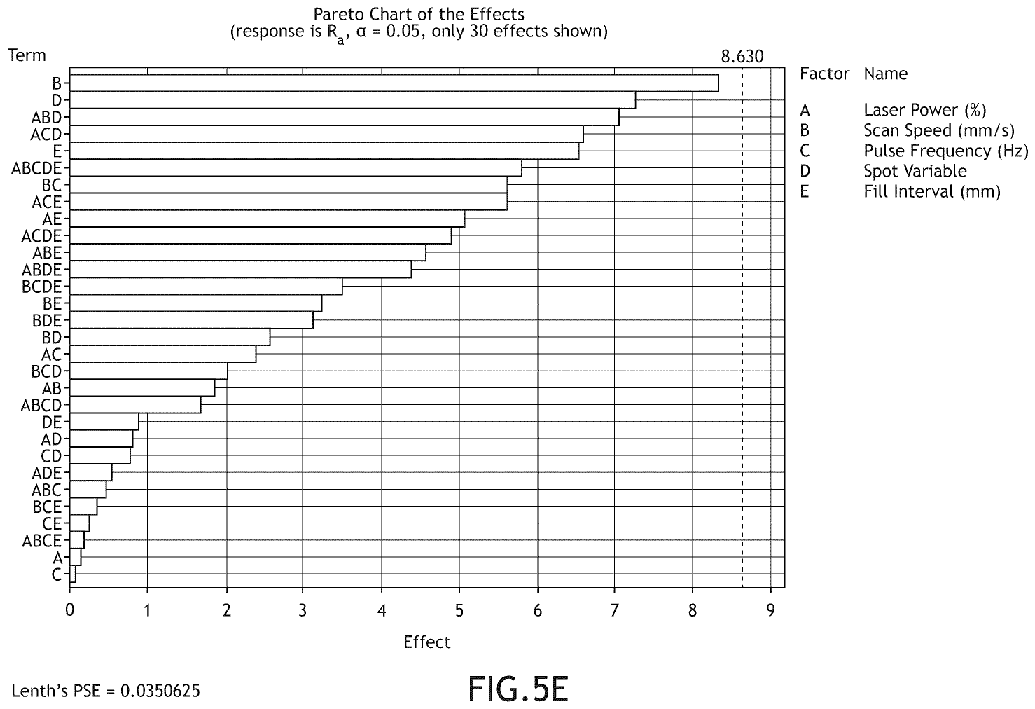

A non-limiting set of experimental results associated with a design of experiments (DOE) analyzing the impact of five different laser processing parameters on a copper wire conductor 104 is depicted in Tables 1 and 2, as well as FIGS. 5A-5E.

For this experiment, a 25 factorial DOE with one midpoint was used to vary five different laser processing parameters: 1. laser power (% of maximum), 2. scan speed (mm/s), 3. pulse frequency (Hz), 4. spot variable, 5. fill interval (mm). The laser power parameter relates to a percentage of a maximum available power for the particular laser. The spot variable is a measure of defocus. In particular, a spot variable parameter of zero represents a smallest spot diameter (e.g., approximately 60 micrometers in this series of experiments), whereas a spot variable parameter of +/−10 would defocus a pulsed beam 118 by 1 mm on either side of best focus (e.g., resulting in a spot diameter of 64 micrometers in this series of experiments). It is to be understood that the use of these particular parameters is merely illustrative and should not be interpreted as limiting the scope of the present disclosure. Rather, the pulsed beams 118 may have any properties suitable for providing laser surface activation of a wire conductor according to any selected metric.

High and low values for the parameters in the factorial DOE were decided on by running a series of preliminary laser parameter matrices to see the effects of different laser conditions on the Cu surface. Laser parameters selected for this DOE were selected based on the conditions that gave a visually distinct surface treatment over the entire laser treated area. High and low values for laser parameters are listed in Table 1 below.

TABLE 1

| Parameter | Low Value | High Value |
|---|---|---|
| Laser Power (% of maximum) | 70 | 90 |
| Scan Speed | 2000 | 4000 |
| Pulse Frequency (Hz) | 50 | 100 |
| Spot Variable | 0 | 10 |
| Fill Interval (mm) | 0.01 | 0.06 |

Table 2 includes the experimental results for the DOE on copper samples. In particular, Table 2 depicts experimental measurements of surface roughness (Rₐ and R_{z}), water receding and advancing contact angles (in degrees (°)), and surface energy (mN/m) based on selected combinations of the five varied laser processing parameters.

TABLE 2

| | | | | | | | | Water | Water | |
|---|---|---|---|---|---|---|---|---|---|---|
| | Laser | Scan | Pulse | | Fil | | | Receding | Advancing | Surface |
| Sample | Power | Speed | Frequency | Spot | Interval | | | Contact | Contact | Energy |
| Number | (%) | (mm/s) | (Hz) | Variable | (mm) | Rₐ | R_{z} | Angle (°) | Angle (°) | (mN/m) |
| 1 | 90 | 4000 | 100 | 0 | 0.01 | 0.87 | 7.95 | 49.0 | 59.0 | 52.69 |
| 2 | 90 | 4000 | 100 | 10 | 0.06 | 0.96 | 8.91 | 47.3 | 75.4 | 38.95 |
| 3 | 90 | 2000 | 100 | 0 | 0.06 | 0.85 | 8.15 | 49.3 | 82.8 | 33.19 |
| 4 | 90 | 4000 | 50 | 10 | 0.06 | 1.14 | 9.88 | 38.8 | 64.3 | 46.57 |
| 5 | 90 | 2000 | 100 | 10 | 0.01 | 0.06 | 4.87 | 50.7 | 60.1 | 52.2 |
| 6 | 90 | 2000 | 50 | 0 | 0.01 | 1.00 | 8.85 | 42.6 | 59.7 | 50.85 |
| 7 | 90 | 2000 | 50 | 10 | 0.06 | 0.87 | 7.50 | 45.4 | 60.4 | 50.84 |
| 8 | 90 | 4000 | 50 | 0 | 0.01 | 0.76 | 6.72 | 69.7 | 79.9 | 39.87 |
| 9 | 90 | 2000 | 100 | 10 | 0.06 | 0.62 | 5.42 | 45.5 | 57.6 | 53.05 |
| 10 | 90 | 4000 | 50 | 0 | 0.06 | 0.97 | 7.78 | 69.0 | 92.0 | 59.18 |
| 11 | 90 | 4000 | 50 | 10 | 0.01 | 0.85 | 6.83 | 61.0 | 90.2 | 29.13 |
| 12 | 90 | 2000 | 50 | 10 | 0.01 | 0.73 | 6.10 | 30.5 | 32.1 | 66.97 |
| 13 | 90 | 4000 | 100 | 0 | 0.06 | 0.87 | 8.27 | 56.8 | 71.4 | 44.18 |
| 14 | 90 | 2000 | 100 | 0 | 0.01 | 0.64 | 5.73 | 46.7 | 60.6 | 50.94 |
| 15 | 90 | 4000 | 100 | 10 | 0.01 | 0.80 | 6.61 | 35.7 | 73.5 | 38.77 |
| 16 | 90 | 2000 | 50 | 0 | 0.01 | 0.69 | 5.91 | 67.5 | 92.2 | 28.72 |
| 17 | 80 | 3000 | 75 | 5 | 0.04 | 0.83 | 6.62 | 79.0 | 95.0 | 28.84 |
| 19 | 70 | 2000 | 100 | 0 | 0.06 | 0.78 | 8.66 | 55.0 | 77.0 | 39.03 |
| 20 | 70 | 2000 | 50 | 0 | 0.06 | 0.88 | 8.03 | 59.0 | 70.0 | 45.89 |
| 21 | 70 | 2000 | 100 | 10 | 0.01 | 0.58 | 4.85 | 20.0 | 54.0 | 52.03 |
| 22 | 70 | 2000 | 50 | 10 | 0.01 | 0.76 | 6.57 | 45.0 | 64.0 | 47.88 |
| 23 | 70 | 2000 | 100 | 10 | 0.06 | 0.75 | 7.14 | 32.0 | 61.0 | 48.16 |
| 24 | 70 | 4000 | 100 | 0 | 0.01 | 0.83 | 7.55 | 33.0 | 70.0 | 41.22 |
| 25 | 70 | 4000 | 50 | 0 | 0.06 | 1.11 | 10.00 | 79.0 | 102.0 | 23.03 |
| 26 | 70 | 2000 | 50 | 10 | 0.06 | 0.69 | 5.84 | 48.0 | 65.0 | 47.65 |
| 27 | 70 | 2000 | 50 | 0 | 0.01 | 0.65 | 5.41 | 39.0 | 41.0 | 63.47 |
| 28 | 70 | 4000 | 100 | 10 | 0.06 | 0.69 | 6.01 | 58.0 | 72.0 | 43.94 |
| 29 | 70 | 2000 | 100 | 0 | 0.01 | 0.66 | 6.59 | 60.0 | 87.0 | 31.59 |
| 30 | 70 | 4000 | 50 | 0 | 0.01 | 0.81 | 7.29 | 51.0 | 65.0 | 48.28 |
| 31 | 70 | 4000 | 50 | 10 | 0.01 | 0.70 | 6.66 | 36.0 | 52.0 | 55.49 |
| 32 | 70 | 4000 | 100 | 0 | 0.06 | 0.85 | 8.56 | 67.0 | 89.0 | 31.29 |
| 33 | 70 | 4000 | 50 | 10 | 0.06 | 1.17 | 8.98 | 55.0 | 85.0 | 32.34 |
| 34 | 70 | 4000 | 100 | 10 | 0.06 | 0.66 | 5.57 | 26.0 | 46.0 | 58.18 |

In the set of experiments described in Table 2, sample numbers 1, 5-7, 9, 10, 12, 14, 21, 27, 31, and 34 all exhibited surface energies greater than 50 mN/m. Further, samples 12 and 27 exhibited surface energies greater than 55 mN/m. As a result, a PEEK coating deposited on such samples is expected to provide sufficient adhesion strength to meet or exceed application tolerances associated with magnet wires in EV motors.

FIGS. 5A-5E depict pareto charts of the impact of various laser processing parameters on surface properties of copper based on the DOE described in Tables 1 and 2. In FIGS. 5A-5E, the impact of various parameters alone and in combination (signified by the Term column) are depicted. Further, a vertical reference line denoted as a represents a significance level, where a value of α=0.05 is provided.

FIG. 5A is a pareto chart depicting an impact of laser processing parameters on Rₐ surface roughness, in accordance with one or more embodiments of the present disclosure. As depicted in FIG. 5A, laser fill interval (mm), laser scan speed (mm/s), and laser pulse frequency (Hz) provide a statistically significant impact on the Rₐ surface roughness (e.g., as shown by values crossing the vertical line) in this experiment.

FIG. 5B is a pareto chart depicting an impact of laser processing parameters on R_{z} surface roughness, in accordance with one or more embodiments of the present disclosure. As depicted in FIG. 5B, laser fill interval (mm), laser scan speed (mm/s) and laser pulse frequency (Hz) provide a statistically significant impact on the R_{z} surface roughness (e.g., as shown by values crossing the vertical line) in this experiment.

FIG. 5C is a pareto chart depicting an impact of laser processing parameters on water receding contact angle, in accordance with one or more embodiments of the present disclosure. As depicted in FIG. 5C, only the spot variable provides a statistically significant impact on the water receding contact angle (e.g., as shown by values crossing the vertical line) in this experiment.

FIG. 5D is a pareto chart depicting an impact of laser processing parameters on water advancing angle, in accordance with one or more embodiments of the present disclosure. As depicted in FIG. 5D, none of the laser processing conditions provide a statistically significant impact on the water advancing contact angle (e.g., as shown by values crossing the vertical line) in this experiment. However, it is noted that the spot variable parameters provides seemingly the greatest impact in this experiment.

FIG. 5E is a pareto chart depicting an impact of laser processing parameters on surface energy, in accordance with one or more embodiments of the present disclosure. As depicted in FIG. 5E, none of the laser processing conditions provide a statistically significant impact on the surface energy (e.g., as shown by values crossing the vertical line) in this experiment. However, it is noted that the scan speed (mm/s) and spot variable parameters provide seemingly the greatest impact in this experiment.

Taken together, Tables 1-2 along with FIGS. 5A-5E illustrate the complex interplay between laser processing parameters and various properties of the resulting surface including, but not limited to, surface energy. In some embodiments of the present disclosure, the laser processing parameters used during run-time of the wire coating system 100 are determined based on a DOE of selected laser processing parameters in a manner similar to that described in Tables 1-2 along with FIGS. 5A-5E. Further, it is to be understood that the particular results illustrated in Tables 1-2 along with FIGS. 5A-5E are merely illustrative and should not be interpreted as limiting the scope of the present disclosure.

Referring again to FIG. 1, various additional aspects of the wire coating system 100 are described in greater detail, in accordance with one or more embodiments of the present disclosure.

The wire coating system 100 may include one or more additional process tools 120 to perform one or more additional processing steps to the wire conductor 104 as it is fed through the working zone 106. The wire coating system 100 may include any number or type of process tools 120 at any location in the working zone 106 such as, but not limited to, before the laser processing sub-system 114, between the laser processing sub-system 114 and the extruder 112, or after the extruder 112.

For example, an additional process tool 120 may include a heating element, which may be used to heat the wire conductor 104 to a selected temperature prior to entering the laser processing sub-system 114 and/or the extruder 112. It is contemplated herein that preheating the wire conductor 104 at least before the extruder 112 may help improve the setting of the coating 216. As an illustration, preheating a copper wire conductor 104 to at least 250° C. or at least 300° C. in some applications may improve the application and setting of a PEEK coating 216. However, this is merely an illustration.

As another example, an additional process tool 120 may include a cooling element, which may be used to cool the coated wire conductor 104 after the extruder 112 and before the wind-up portion of the feed mechanism 102.

Additionally, though not explicitly shown, the wire coating system 100 may include an in-line analysis sub-system, which may analyze the quality of the wire conductor 104 and/or the coating 216 prior to the wind-up portion of the feed mechanism 102.

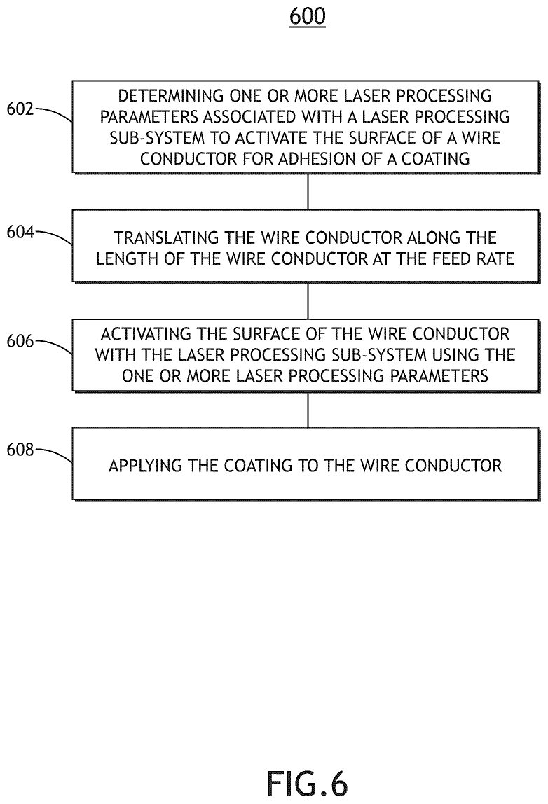

FIG. 6 is a flow diagram illustrating steps performed in a method 600 for laser surface activation, in accordance with one or more embodiments of the present disclosure. The embodiments and enabling technologies described previously herein in the context of the wire coating system 100 should be interpreted to extend to the method 600. It is further noted, however, that the method 600 is not limited to the architecture of the wire coating system 100.

In embodiments, the method 600 includes a step 602 of determining one or more laser processing parameters (e.g., associated with a laser processing sub-system 114) to activate a surface of a wire conductor 104 for adhesion of a coating 216. For example, the step 602 may include illuminating the surface of the wire conductor 104 with two or more beams 118 of laser light. Further, the laser processing parameter may include any combination of parameters associated with the beams 118 such as, but not limited to, spectral properties (e.g., wavelength, bandwidth, or the like), temporal properties (e.g., pulse duration and/or a temporal pulse pattern when the beams 118 are pulsed), or spatial (e.g., a fill interval associated with an overlap between pulses on the wire conductor 104 when the beams 118 are pulsed). Additionally, the laser processing parameters may include a feed rate associated with translation of the wire conductor 104 along a feed direction 402 (e.g., a line direction associated with a length of the wire conductor 104).

The laser processing parameters suitable for activating the surface of the wire conductor 104 may be determined using any suitable technique. For example, the laser parameters may be determined using a DOE in which various candidate laser processing parameters are varied according to known amounts and where the impact of these variations on a desired parameter associated with adhesion of the coating 216 are measured.

In some embodiments, the laser processing parameters are selected in step 604 to increase a surface energy of the wire conductor 104 to meet or exceed a selected threshold value. For example, it may be desirable to increase the surface energy of a copper wire conductor 104 to meet or exceed a selected threshold value of 50 nM/m to promote adhesion of a PEEK coating 216.

Further, the laser processing parameters may be selected to promote adhesion of a coating 216 through any light-matter interaction mechanism. In some embodiments, the laser processing parameters are selected to remove surface contaminants (e.g., by evaporation, sublimation, ablation, or any other mechanism). In this configuration, the surface roughness may remain unchanged (at least within a selected tolerance) or may be increased (e.g., through ablation of the wire conductor 104 or any other mechanism). In some embodiments, the laser processing parameters are selected to modify the surface roughness (e.g., the Ra and/or Rz surface roughness) by a selected tolerance (e.g., through ablation of the wire conductor 104 or any other mechanism). In some embodiments, the laser processing parameters are selected to increase a water contact angle (e.g., a hydrophilicity) of the wire conductor 104 (e.g., an advancing and/or a receding contact angle) to promote adhesion of the coating 216.

In embodiments, the method 600 includes a step 604 of translating the wire conductor along the length of the wire conductor at the feed rate. In embodiments, the method 600 includes a step 606 of activating the surface of the wire conductor 104 with the laser processing sub-system 114 using the one or more laser processing parameters. In embodiments, the method 600 includes a step 608 of applying the coating 216 to the wire conductor 104. For example, the steps 604-608 may be associated with a run-time operation in which a coating 216 is applied based on laser surface activation (step 606) using parameters known to promote adhesion of the coating 216 as determined in step 602.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

### LIST OF REFERENCE NUMBERS

100 wire coating system
102 feed mechanism
104 wire conductor
106 working zone
108 payoff side
110 wind-up side
112 extruder
114 laser processing sub-system
116 one or more laser sources
118 beams
120 additional process tool
202 mandril
204 feed-through opening
206 die
208 tapered opening
210 feed-through opening
212 coating material
214 channel
216 coating
402 feed direction
404 beamsplitters
406 mirrors
408 beamshaping optical elements
600 method
602 step
604 step
606 step
608 step

1. A coating system comprising:
a feed mechanism including one or more rollers configured to provide a supply of a wire conductor through a working zone with a feed rate;
an extruder to coat the wire conductor with a coating as the wire conductor is fed through the working zone; and
a laser processing sub-system in the working zone prior to the extruder, wherein the laser processing sub-system comprises one or more laser sources configured to illuminate a surface of the wire conductor with two or more laser beams as the wire conductor is fed through the working zone, wherein one or more laser processing parameters associated with the laser processing sub-system are selected to activate the surface of the wire conductor for adhesion of the coating, wherein the one or more laser processing parameters comprise at least one of intensities of the two or more laser beams, spectra of the two or more laser beams, or the feed rate.

2. The coating system of claim 1, wherein the one or more laser processing parameters are selected to activate the surface of the wire conductor for adhesion of the coating by increasing a surface energy of the surface of the wire conductor.

3. The coating system of claim 1, wherein the one or more laser processing parameters are selected to activate the surface of the wire conductor for adhesion of the coating by removing contaminants from the surface of the wire conductor.

4. The coating system of claim 1, wherein the one or more laser processing parameters are selected to activate the surface of the wire conductor for adhesion of the coating by increasing a surface roughness of the surface of the wire conductor.

5. The coating system of claim 1, wherein the two or more laser beams are arranged to illuminate an entire surface of the wire conductor with the two or more laser beams as the wire conductor is fed through the working zone.

6. The coating system of claim 5, wherein the two or more laser beams are arranged in a non-overlapping configuration.

7. The coating system of claim 1, wherein the two or more laser beams comprise:
two or more pulsed laser beams, wherein the one or more laser processing parameters further include at least one of a temporal pattern or a spatial pattern of pulses in the two or more pulsed laser beams.

8. The coating system of claim 1, wherein the coating comprises polyether ether ketone (PEEK), wherein the wire conductor comprises copper.

9. The coating system of claim 8, wherein the one or more laser processing parameters are selected to activate the surface of the wire conductor for adhesion of the coating by increasing a surface energy of the surface of the wire conductor above 50 mN/m.

10. A system for laser processing comprising:
one or more laser sources configured to illuminate a surface of a wire conductor with one or more laser beams as the wire conductor is translated along a length of the wire conductor at a feed rate, wherein one or more laser processing parameters associated are selected to activate the surface of the wire conductor for adhesion of a coating, wherein the one or more laser processing parameters comprise at least one of intensities of the one or more laser beams or the feed rate.

11. The system of claim 10, wherein the one or more laser processing parameters are selected to activate the surface of the wire conductor for adhesion of the coating by increasing a surface energy of the surface of the wire conductor.

12. The system of claim 10, wherein the one or more laser processing parameters are selected to activate the surface of the wire conductor for adhesion of the coating by removing contaminants from the surface of the wire conductor.

13. The system of claim 10, wherein the one or more laser processing parameters are selected to activate the surface of the wire conductor for adhesion of the coating by increasing a surface roughness of the surface of the wire conductor.

14. The system of claim 10, wherein the coating comprises polyether ether ketone (PEEK), wherein the wire conductor comprises copper.

15. The system of claim 14, wherein the one or more laser processing parameters are selected to activate the surface of the wire conductor for adhesion of the coating by increasing a surface energy of the surface of the wire conductor above 50 mN/m.

16. A laser surface activation method comprising:
determining one or more laser processing parameters associated with a laser processing sub-system to activate the surface of a wire conductor for adhesion of a coating, wherein the laser processing sub-system comprises one or more laser sources configured to illuminate a surface of the wire conductor with two or more laser beams as the wire conductor is translated along a length of the wire conductor at a feed rate, wherein the one or more laser processing parameters comprise at least one of intensities of the two or more laser beams, spectra of the two or more laser beams, or the feed rate;
translating the wire conductor along the length of the wire conductor at the feed rate;
activating the surface of the wire conductor with the laser processing sub-system using the one or more laser processing parameters; and
applying the coating to the wire conductor.

17. The method of claim 16, wherein the one or more laser processing parameters are selected to activate the surface of the wire conductor for adhesion of the coating by increasing a surface energy of the surface of the wire conductor.

18. The method of claim 16, wherein the one or more laser processing parameters are selected to activate the surface of the wire conductor for adhesion of the coating by removing contaminants from the surface of the wire conductor.

19. The method of claim 16, wherein the one or more laser processing parameters are selected to activate the surface of the wire conductor for adhesion of the coating by increasing a surface roughness of the surface of the wire conductor.

20. The method of claim 16, wherein the coating comprises polyether ether ketone (PEEK), wherein the wire conductor comprises copper, wherein the one or more laser processing parameters are selected to activate the surface of the wire conductor for adhesion of the coating by increasing a surface energy of the surface of the wire conductor above 50 mN/m.
